(19) United States
(12) Patent Application Publication
(10) Pub. No.: US 2024/0390979 A1
(43) Pub. Date: Nov. 28, 2024

(54) METHOD FOR THE ADDITIVE MANUFACTURE OF A COPPER OBJECT

(71) Applicant: ADDUP, Cebazat (FR)

(72) Inventor: ETIENNE BLANCHET, Cebazat (FR)

(21) Appl. No.: 18/695,197

(22) PCT Filed: Sep. 19, 2022
(86) PCT No.: PCT/FR2022/051754

§ 371 Date: Mar. 25, 2024

(30) Foreign Application Priority Data
Sep. 27, 2021 (FR) FR2110152

(51) Int. Cl. B22F 10/28; B22F 12/41; B33Y 10/00; B33Y 70/00

(52) U.S. Cl. CPC B22F 10/28; B22F 12/41; B22F 2301/10; B33Y 10/00; B33Y 70/00

(57) ABSTRACT

A method for additive manufacturing of a copper object comprises manufacturing the object by selective fusion of powder layers superposed on a support, the selective fusion of a powder layer being obtained by the movement or sweeping of a laser beam over the powder layer, wherein the powder layer is metallic and comprises at least 95% by mass of copper. Each fusion zone of each powder layer is swept at least twice by the laser beam, the first sweep of the laser beam allowing creation of a film of nanoparticles in the surface of the powder present in each fusion zone, wherein this nanoparticle film reduces the reflectivity of the powder in each fusion zone, and the second sweep of the laser beam fusing the powder in each fusion zone due to the presence of the nanoparticle film created by the first sweep.

The present invention relates to additive manufacturing by powder bed deposition and selective fusion of a copper object.

More precisely, the invention is intended to allow the additive manufacturing of copper objects having a material density greater than 99%.

Copper is used in numerous applications because of its high thermal conductivity and/or high electrical conductivity. For example, copper is very often used for creation of electrical connections inside all types of electrical devices.

By allowing the production of complex parts, additive manufacturing may allow production of copper objects offering new functions or improved functions.

However, the strong reflectivity of copper to light and its high thermal conductivity do not support the use of additive manufacturing by powder bed deposition and selective fusion with a laser beam. Firstly, the strong reflectivity of copper greatly reduces the energy transmitted by the laser beam to the powder layer, and secondly, the high thermal conductivity promotes the dissipation of heat in the powder layer by conduction and hence reduces the quality of the fusion bath.

To remedy these difficulties, it is possible to use copper alloyed with other materials such as chromium or molybdenum. Documents JP2020059870 and WO201902122 propose the additive manufacturing of objects with such alloys.

Although objects manufactured with these copper alloys may suit certain applications, there are also applications, in particular electrical, in which these objects cannot be used or do not offer the desired performance since the added metals—chromium or molybdenum—reduce the electrical conductivity of the manufactured object.

The object of the present invention is to allow the manufacture of copper objects by a method of additive manufacturing by powder bed deposition and selective fusion from a metal powder containing at least 95% by mass of copper.

Document FR2980380 proposes a strategy for additive manufacturing of a metal part by powder bed deposition and selective fusion which, for each layer of the part produced, comprises at least two successive sweeps of a same zone of the powder layer with a laser beam or an electron beam.

According to document FR2980380, this double sweep allows better control of the manufacturing process, reduces the risks of cracking and generates layers of material of greater density without creating excessive thermal gradients, and homogenizes the material of the parts thus produced.

Document FR2980380 mentions alloys René 77, TiAl or a nickel-based super-alloy, but does not concern the manufacture of copper objects.

Surprisingly, it has been found by the inventor that the use of a double sweep as described in document FR2980380 allows the additive manufacturing of copper objects from a metal powder comprising at least 95% by mass of copper, and allows the manufacture of copper objects with a material density greater than 99%.

Thus the invention concerns a method for additive manufacturing of a copper object, being a method for additive manufacturing by powder bed deposition and selective fusion, said object being manufactured by selective fusion of powder layers superposed on a support, the selective fusion of a powder layer being obtained by the movement or sweeping of a laser beam over said powder layer, wherein the powder layer used by the method is metallic and comprises at least 95% by mass of copper.

According to the invention, each fusion zone of each powder layer is swept at least twice by the laser beam, the first sweep of the laser beam allowing creation of a film of nanoparticles in the surface of the powder present in each fusion zone, wherein this nanoparticle film reduces the reflectivity of the powder in each fusion zone, and the second sweep of the laser beam fuses the powder in each fusion zone thanks to the presence of the nanoparticle film created by the first sweep.

Advantageously, but not necessarily, the invention may also provide that:
the two sweeps of each fusion zone are carried out with a laser beam having a wavelength between 1030 nm and 1100 nm, more precisely between 1050 nm and 1090 nm, and preferably between 1060 nm and 1080 nm,
the first sweep is performed in conductive mode and the second sweep is performed in keyhole mode,
each sweep of each fusion zone comprising parallel vectors, the inter-vector space during the second sweep is equal to or smaller than the inter-vector space during the first sweep,
the inter-vector space during the second sweep is between 50% and 80% of the inter-vector space during the first sweep,
the size of the spot of the laser beam is greater during the first sweep than during the second sweep,
the size of the spot of the laser beam during the first sweep is between 120% and 140% of the size of the spot of the laser beam during the second sweep,
the inter-vector space during the second sweep being equal to the inter-vector space during the first sweep, the vectors of the second sweep are parallel with the vectors of the first sweep and interposed between the vectors of the first sweep,
each sweep of each fusion zone comprising parallel vectors, the vectors of the second sweep are not parallel to the vectors of the first sweep,
the power of the laser beam used for the first sweep is greater than or equal to the power of the laser beam used for the second sweep,
the power of the laser beam used for the first sweep is between 115% and 140% of the power of the laser beam used for the second sweep,
the movement speed of the spot of the laser beam used for the first sweep is greater than or equal to the movement speed of the spot of the laser beam used for the second sweep,
the movement speed of the spot of the laser beam used for first sweep is between 110% and 150% of the movement speed of the spot of the laser beam used for the second sweep,
the inter-vector space during the second sweep is smaller than the inter-vector space during the first sweep, while the size of the spot of the laser beam, the power of the laser beam and the movement speed of the spot of the laser beam are identical during both sweeps.

Further features and advantages of the invention will become apparent from the following description, this description being given as a non-limitative example.

The invention relates to a method for additive manufacturing of a copper object from a metal powder comprising at least 95% by mass of copper. More particularly, the invention is intended to allow the additive manufacturing of a copper object having a material density greater than or equal to 99.6%.

In the context of additive manufacturing, the material density of the manufactured object is directly linked to the quality of the fusion bath and to the porosity created in the object by use of selective fusion. For example, an object with a material density equal to 100% contains no porosity, and an object with a material density equal to 90% contains 10% by volume of pores, i.e. gaps filled with gas and not solid material. The aim is generally to avoid porosity since it reduces the mechanical characteristics of the manufactured object and also its electrical and thermal conductivity. The material density of a manufactured object is preferably measured by destructive cutting of an object, then polishing and analysis of the image (measurement of ratio: holes/solid matter). Alternatively, the material density of a manufactured object may be measured by tomography using the Archimedes principle or with a pycnometer.

According to the invention, the method used is a method of additive manufacturing by powder bed deposition and selective fusion. Additive manufacturing by powder bed deposition and selective fusion is an additive manufacturing method in which one or more object(s) is/are manufactured by the selective fusion of various mutually superposed layers of additive manufacturing powder. The first layer of powder is deposited onto a support such as a platform, then selectively fused using one or more source(s) of energy or heat along a first horizontal section of the one or more object(s) to be manufactured. Then, a second layer of powder is deposited on the first layer of powder which has just been fused, and this second layer of powder is then itself selectively fused, and so on up to the last layer of powder used for manufacturing the last horizontal section of the object(s) to be manufactured.

In the present invention, the selective fusion of a powder layer is obtained by the movement or sweeping of at least one laser beam over said powder layer.

The method according to the invention concerns in particular the manufacture of copper objects with a laser beam having a wavelength between 1030 nm and 1100 nm, more precisely between 1050 nm and 1090 nm, and preferably between 1060 nm and 1080 nm.

In comparison with a laser beam with shorter wavelength, situated e.g. around 532 nm, the use of a laser beam with wavelength between 1030 nm and 1100 nm offers a greater focal distance and hence the possibility of manufacturing objects of larger dimensions. Furthermore, a laser beam with wavelength between 1030 nm and 1100 nm offers a larger diameter and hence a greater productivity than a laser beam of shorter wavelength, situated e.g. around 532 nm.

However, on a copper powder layer, the reflectivity of a laser beam with wavelength between 1030 nm and 1100 nm is greater than the reflectivity of a laser beam with shorter wavelength, situated e.g. around 532 nm. Consequently, the laser beam with greater wavelength offers a lower absorption rate and transmits less energy to the copper powder than the laser beam with shorter wavelength. The method according to the invention aims in particular to remedy this drawback and allow the manufacture of copper objects with a laser beam having a wavelength between 1030 nm and 1100 nm.

To this end, the method according to the invention provides that each fusion zone of each powder layer is swept at least twice by the laser beam, the first sweep of the laser beam allowing creation of a film of nanoparticles in the surface of the powder present in each fusion zone, wherein this nanoparticle film reduces the reflectivity of the powder in each fusion zone, and the second sweep of the laser beam fuses the powder in each fusion zone thanks to the presence of the nanoparticle film created by the first sweep.

The nanoparticle film created by the first sweep of the laser beam is a thin layer of nanoparticles at least partially covering the powder layer to be fused.

A fusion zone of a powder layer is a zone corresponding to the section of an object to be manufactured with this powder layer, or to the section of a support of an object to be manufactured with this powder layer.

The first sweep of a fusion zone by the laser beam is mainly intended to create the nanoparticle film. However, the powder may also be partially fused after this first sweep. Advantageously, this partial fusion of the powder after the first sweep does not reduce the quality of the fusion created by the second sweep, in particular because the nanoparticles are also present on the partially fused powder.

The nanoparticle film allows a reduction in reflectivity of the powder by increasing the roughness of the surface of the powder layer. This increase in roughness is reflected by an increase in the number of cavities in the surface of the powder, which allows the photons of the laser beam to be trapped and hence improves the transfer of energy between the laser beam and the powder during the second sweep. Since it allows the photons and hence the light of the laser beam to be trapped, the nanoparticle film also has a darker colour than the powder it covers.

To give an idea, the nanoparticles have a granulometry around 1000 times smaller than the granulometry of the powder used in the method according to the invention. For example, when the copper powder has a granulometry between 15 and 45 μm, these nanoparticles have a granulometry between 25 and 75 nm.

The nanoparticles may be isolated or agglomerated with one another. If the nanoparticles are agglomerated with one another, they can still reduce the reflectivity of the powder.

Preferably, the first sweep is carried out in conductive mode.

It should be noted that if the person skilled in the art were to attempt the additive manufacturing of copper objects, the result of this first sweep would normally be regarded as failure since the powder layer has little or no fusion and has a rougher appearance than before. It is therefore probable that the person skilled in the art would stop at this first sweep and seek means of improving the quality of fusion during the first sweep.

The method according to the invention therefore uses a first step, namely the first sweep, the result of which is generally regarded as failure because of the poor quality of fusion of the powder. However, in the present invention, the increase in roughness of the powder obtained with the first sweep achieves a reduction in reflectivity of the powder and hence guarantees a good quality of fusion during the second sweep by improving the rate of energy absorption of the laser beam by the powder during the second sweep.

The good quality of fusion obtained during the second sweep is demonstrated in particular by the low rate of porosity present in the copper object manufactured with the method according to the invention. Thus a copper object obtained with the additive manufacturing method according to the invention has a material density greater than or equal to 99.6%.

For example, the two sweeps of each fusion zone are carried out with a laser beam having a wavelength between 1030 nm and 1100 nm, more precisely between 1050 nm and 1090 nm, and preferably between 1060 nm and 1080 nm. However, the method according to the invention may also be used with a laser beam with a shorter wavelength, situated for example around 532 nm. In this case, the method according to the invention serves above all to increase productivity.

Preferably, the second sweep of each fusion zone is carried out in keyhole mode.

For example, each sweep of each fusion zone comprises parallel vectors. These parallel vectors are for example arranged at regular intervals from one another, this interval being designated the inter-vector space. This sweeping technique is in particular known as hatching.

Preferably, in the method according to the invention, the inter-vector space during the second sweep is equal to or smaller than the inter-vector space during the first sweep. In other words, the first sweep may be carried out with greater inter-vector spacing, for example in order to reduce the time devoted to this first sweep. For example, the inter-vector space during the first sweep is between 100 and 300 μm, and preferably between 150 μm and 200 μm. Preferably, the inter-vector space during the second sweep is between 50% and 80% of the inter-vector space during the first sweep.

In the case where the inter-vector space during the second sweep is equal to the inter-vector space during the first sweep, the vectors of the second sweep are for example parallel with the vectors of the first sweep and interposed between the vectors of the first sweep. A vector of the second sweep is interposed with the vectors of the first sweep when the vector of the second sweep is situated between two vectors of the first sweep. For example, a vector of the second sweep is situated between two vectors of the first sweep and equidistant from these two vectors of the first sweep.

In some cases, if each sweep of each fusion zone comprises parallel vectors, the vectors of the second sweep may not be parallel to the vectors of the first sweep. In this case, there is an angular offset between the vectors of the first sweep and the vectors of the second sweep.

Preferably, in the method according to the invention, the power of the laser beam used for the first sweep is greater than or equal to the power of the laser beam used for the second sweep. For example, the power of the laser beam used for the two sweeps is between 700 and 1000 W. Preferably, the power of the laser beam used for this first sweep is at least equal to 800 W. For example, the power of the laser beam used for the first sweep is between 115% and 140% of the power of the laser beam used for the second sweep.

Preferably, in the method according to the invention, the movement speed of the spot of the laser beam used for the first sweep is greater than or equal to the movement speed of the spot of the laser beam used for the second sweep. In other words, it is possible to generate the nanoparticle film with a laser beam which moves more quickly, but it is preferable to retain a moderate speed during the second sweep in order to guarantee a good fusion quality. For example, these movement speeds are between 300 and 1000 m/s. For example, the movement speed of the spot of the laser beam used for first sweep is between 110% and 150% of the movement speed of the spot of the laser beam used for the second sweep.

In some cases, in the method according to the invention, the size of the spot of the laser beam is greater during the first sweep during the second sweep. For example, the size of the spot of the laser beam during the first sweep is between 100 and 200 μm, and preferably between 120 μm and 180 μm. The size of the spot of the laser beam is for example measured on the powder layer to be fused. For example, the size of the spot of the laser beam during the first sweep is between 120% and 140% of the size of the spot of the laser beam during the second sweep. The size of the spot of the laser beam is its diameter when the spot is circular or corresponds to the greatest dimension of the spot when it has a different shape.

In an embodiment of the method according to the invention, the inter-vector space during the second sweep is smaller than the inter-vector space during the first sweep, and the size of the spot of the laser beam, the power of the laser beam and the movement speed of the spot of the laser beam are identical during both sweeps.

The present invention thus concerns a copper object manufactured additively with the method just described, wherein the object is produced layer by layer and has a material density greater than or equal to 99.6%. It is noted that a copper object manufactured additively with the method according to the invention has a metallurgical structure specific to additively manufactured objects and different from the metallurgical structure of copper objects manufactured by other methods such as casting or forging for example. For example, when an object manufactured additively layer by layer is cut open in a plane perpendicular to these layers, the different superposed layers and the fusion beads can be distinguished using suitable equipment.

1.-14. (canceled)

15. A method for additive manufacturing of a copper object comprising:
selectively fusing powder layers superposed on a support, selective fusion of a powder layer being obtained by movement of a laser beam over the powder layer,
wherein the powder layer is metallic and comprises at least 95% by mass of copper,
wherein each fusion zone of a powder layer is swept at least twice by the laser beam, a first sweep of the laser beam allowing creation of a nanoparticle film in a surface of the powder present in each fusion zone, the nanoparticle film reducing reflectivity of the powder in each fusion zone, and the second sweep of the laser beam fusing the powder in each fusion zone due to a presence of the nanoparticle film created by the first sweep.

16. The method for additive manufacturing of a copper object according to claim 15, wherein the two sweeps of each fusion zone are carried out with a laser beam having a wavelength between 1030 nm and 1100 nm.

17. The method for additive manufacturing of a copper object according to claim 15, wherein the first sweep is performed in conductive mode and wherein the second sweep is performed in keyhole mode.

18. The method for additive manufacturing of a copper object according to claim 15, wherein, each sweep of each fusion zone comprising parallel vectors, an inter-vector space during the second sweep is equal to or smaller than an inter-vector space during the first sweep.

19. The method for additive manufacturing of a copper object according to claim 18, wherein the inter-vector space during the second sweep is between 50% and 80% of the inter-vector space during the first sweep.

20. The method for additive manufacturing of a copper object according to claim 18, wherein a size of a spot of the laser beam is greater during the first sweep than during the second sweep.

21. The method for additive manufacturing of a copper object according to claim 20, wherein the size of the spot of the laser beam during the first sweep is between 120% and 140% of a size of the spot of the laser beam during the second sweep.

22. The method for additive manufacturing of a copper object according to claim 18, wherein, the inter-vector space during the second sweep being equal to the inter-vector space during the first sweep, vectors of the second sweep are parallel with vectors of the first sweep and interposed between the vectors of the first sweep.

23. The method for additive manufacturing of a copper object according to claim 15, wherein, each sweep of each fusion zone comprising parallel vectors, vectors of the second sweep are not parallel to vectors of the first sweep.

24. The method for additive manufacturing of a copper object according to claim 15, wherein a power of the laser beam used for the first sweep is greater than or equal to a power of the laser beam used for the second sweep.

25. The method for additive manufacturing of a copper object according to claim 24, wherein the power of the laser beam used for the first sweep is between 115% and 140% of the power of the laser beam used for the second sweep.

26. The method for additive manufacturing of a copper object according to claim 15, wherein a movement speed of a spot of the laser beam used for the first sweep is greater than or equal to a movement speed of a spot of the laser beam used for the second sweep.

27. The method for additive manufacturing of a copper object according to claim 26, wherein the movement speed of the spot of the laser beam used for first sweep is between 110% and 150% of the movement speed of the spot of the laser beam used for the second sweep.

28. The method for additive manufacturing of a copper object according to claim 18, wherein the inter-vector space during the second sweep is smaller than the inter-vector space during the first sweep, and wherein a size of a spot of the laser beam, a power of the laser beam and a movement speed of the spot of the laser beam are identical during both sweeps.
